(19) United States
(12) Patent Application Publication
(10) Pub. No.: US 2008/0028374 A1
(43) Pub. Date: Jan. 31, 2008

(54) METHOD FOR VALIDATING AMBIGUOUS W3C SCHEMA GRAMMARS

(75) Inventors: Moshe E. Matsa, Cambridge, MA (US); Eric Perkins, Boston, MA (US)

Correspondence Address: CANTOR COLBURN LLP-IBM YORKTOWN, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/460,044

(22) Filed: Jul. 26, 2006

(51) Int. Cl. G06F 9/45; G06F 17/00

(52) U.S. Cl. 717/141; 715/237; 717/143

(57) ABSTRACT

A method for generating XML (Extensible Markup Language) parsers, including: parsing an input document with a generated parser where the generated parser is generated by a three-stage compilation of an XML Schema, where in a first stage the XML Schema is read and modeled in terms of abstract schema components, where in a second stage the XML Schema is augmented with a set of calculated schema components and properties, and where in a third stage the XML Schema is traversed to generate validation code; the validation code is generated by: calculating prohibited occurrence ranges; generating code to: evaluate each of the plurality of particles in an inner loop conditioned on an effective upper bound; then, once the inner loop terminates, check forbidden occurrence ranges for an inner particle, and calculate a range of possible repetitions of an outer particle; and once an outer loop terminates, check a range of total possible repetitions of the outer particle against its actual occurrence limits.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to schema grammars, and particularly to a method of validating ambiguities of schema grammars by eliminating DFA (Deterministic Finite Automata) based schemes that evaluate content models.

2. Description of Background

XML (Extensible Markup Language) has begun to work its way into the business computing infrastructure and underlying protocols such as the Simple Object Access Protocol (SOAP) and Web services. In the performance-critical setting of business computing, however, the flexibility of XML becomes a liability due to the potentially significant performance penalty. XML processing is conceptually a multitiered task, an attribute it inherits from the multiple layers of specifications that govern its use including: XML, XML namespaces, XML Information Set (Infoset), and XML Schema. Traditional XML processor implementations reflect these specification layers directly. Bytes, read off the “wire” or from disk, are converted to some known form. Attribute values and end-of-line sequences are normalized. Namespace declarations and prefixes are resolved, and the tokens are then transformed into some representation of the document Infoset. The Infoset is optionally checked against an XML Schema grammar (XML schema, schema) for validity and rendered to the user through some interface, such as Simple API for XML (SAX) or Document Object Model (DOM) (API stands for application programming interface).

With the widespread adoption of SOAP and Web services, XML-based processing, and parsing of XML documents in particular, is becoming a performance-critical aspect of business computing. In such scenarios, XML is invariably constrained by an XML Schema grammar, which can be used during parsing to improve performance. Although traditional grammar-based parser generation techniques could be applied to the XML Schema grammar, the expressiveness of XML Schema does not lend itself well to the generic intermediate representations associated with these approaches.

Indeed, for parsing in domains other than XML (e.g., programming languages), grammars have long been used to generate optimized special purpose parsers that operate much more efficiently than their generic counterparts while performing validation checking. The XML specifications were designed to enable the compilation of an XML Schema grammar to a special-purpose parser. However, traditional parser-generation schemes are not particularly well suited to XML parsing and have difficulty representing some XML Schema constructs that are not found in traditional parsing situations. Furthermore, traditional models are inefficient as intermediate representations of the schema. Traditional automaton based schemes are used to eliminate non-determinism in the grammar, and thus to generate efficient parsers. XML Schema, however, already enforces a constraint on all schemas called the Unique Particle Attribution Constraint, which mandates that XML Schema content models be deterministic. This built-in determinism greatly simplifies parser generation, eliminating the need for DFA-based schemes to arrive at simple, efficient parsers for XML.

The UPA does not, however, eliminate all ambiguities for bounded-range content models. In particular, grammars defined by W3C (World Wide Web Consortium) XML Schema are not, strictly speaking, LL(1). The rules of XML Schema demand only that element information items be uniquely attributed, without lookahead, to particles in the schema. Due to the relative complexity of occurrences allowed on individual particles, and the composability of those particles, it is possible to define grammars for which the particle is uniquely attributable, but which are not LL(1) because a whole sequence of repeated information items must be processed before the validity determination on the occurrence can be made. The canonical example is (A{i,j}B{0,k}){1,m} for any i, j, k, l, m where 0<(j−i)<i−1 and where m>1. In this case, a sequence of information items matching the production for A must be read in its entirety, before the occurrence range can be evaluated. For example, if i=3 and j=4, a sequence of A's may be of length 3, 4, 6, 7 or 8, but not 5. This situation can be handled by DFA (Deterministic Finite Automata) based validation, but this involves an exponential blowup of DFA states.

It is therefore well known that, apart from the particular legal ambiguous cases outlined above, the UPA prohibits ambiguity in XML Schema content models, and therefore simplifies the task of validation such that DFA-based schemes are not needed to ensure deterministic control flow. Considering the limitations of DFA-based schemes, it is desirable, therefore, to formulate a method for validation of the specifically legal ambiguous cases that does not rely on DFA-based methods, so as to completely eliminate the need for DFA-based schemes in XML Schema validation.

### SUMMARY OF THE INVENTION

The shortcomings of the prior art are overcome and additional advantages are provided through the provision of a method for generating XML (Extensible Markup Language) parsers through compilation of XML Schema grammars, the method comprising: parsing an input document with a generated parser, where the generated parser is generated by a three-stage compilation of an XML Schema, where in a first stage the XML Schema is read and modeled in terms of abstract schema components, where in a second stage the XML Schema is augmented with a set of calculated schema components and properties used to drive code generation, and where in a third stage the XML Schema is traversed to generate validation code for each of a collection of elements; wherein the validation code for ambiguous but legal content models is generated by: calculating prohibited occurrence ranges for each of the plurality of particles involved; generating code to: evaluate each of the plurality of particles in an inner loop conditioned on an effective upper bound; then, once the inner loop terminates, check forbidden occurrence ranges for an inner particle, and calculate a range of possible repetitions of an outer particle; and once an outer loop terminates, check a range of total possible repetitions of the outer particle against actual occurrence limits of the outer particle.

Additional features and advantages are realized through the techniques of the present invention. Other embodiments and aspects of the invention are described in detail herein and are considered a part of the claimed invention. For a better understanding of the invention with advantages and features, refer to the description and the drawings.

### Technical Effects

As a result of the summarized invention, technically we have achieved a solution that eliminates large code/memory blowup for bounded range content models by eliminating the need for a DFA based scheme that evaluates content models.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIGS. 1 and 2 illustrate one example of a flow diagram describing validation of a content model where the complexity of the content model is directly related to the complexity of the content-model expression itself, and

FIGS. 3-5 illustrate one example of a flow diagram describing validation of a content model where the ambiguous pattern is extended with an additional level of nesting.

### DETAILED DESCRIPTION OF THE INVENTION

One aspect of the exemplary embodiments is a method for validating ambiguous schema grammars. Another aspect of the exemplary embodiments is a method of evaluating particles in a loop conditioned on an effective upper bound in order to calculate occurrence ranges prohibited by constraints.

XML is the Extensible Markup Language. It improves the functionality of the Web by allowing a user to identify information in a more accurate, flexible, and adaptable way. It is extensible because it is not a fixed format like HTML, which is a single, predefined markup language. Instead, XML is actually a meta-language, that is, a language for describing other languages that allows a user to design his/her own markup languages for limitless different types of documents.

The purpose of a schema is to define a class of XML documents, and so the term “instance document” is often used to describe an XML document that conforms to a particular schema. In fact, neither instances nor schemas need to exist as documents per se. They may exist as streams of bytes sent between applications, as fields in a database record, or as collections of XML Infoset “Information Items.” Also, developing schema requires specifying formal data typing and validation of element content in terms of data types.

In XML Schema, there is a basic difference between complex types, which allow elements in their content and may carry attributes, and simple types, which cannot have element content and cannot carry attributes. There is also a major distinction between definitions, which create new types (both simple and complex), and declarations, which enable elements and attributes with specific names and types (both simple and complex) to appear in document instances.

New complex types are defined using the ‘complex type’ element and such definitions typically contain a set of element declarations, element references, and attribute declarations. The declarations are not themselves types, but rather an association between a name and the constraints, which govern the appearance of that name in documents, governed by the associated schema. Elements are declared using the ‘element’ element, and attributes are declared using the ‘attribute’ element.

Like the Document Type Definition (DTD) grammar used in XML, XMS, Schema can specia, an element's content model as a regular expression over its contained element. In contrast to the gramnears that can be specified with an XML DTD however, XML. Schema supports a wider range of operators in the composition of content models.

To represent and operate on the XML Schema grammar, a publicly available implementation of the schema components is utilized. The schema components, taken in aggregate, are referred to as the schema. It is assumed that the schema for any given grammar is fully resolved before compilation begins; that is, there are no missing subcomponents, and no attempt will be made to further resolve components. The schema components have four primary component types: element declarations, attribute declarations, complex type definitions, and simple type definitions. Complex type definitions also reference a set of helper components: particle, model group, wildcard, and attribute use.

Complex types may have content that is simple, complex, or empty. In the case when the content is simple, the value of the content-type property is a simple-type definition that defines the content. In the case when the content is empty, the content type is empty. If the complex type has complex content, then the content-type is a particle, which defines a complex content model. The content model for such a complex type is defined in terms of the helper components (particles, model groups, and wildcards). A particle is the basic unit of an XML Schema content model. Every particle has an occurrence range and a term. The term is the model-group, element-declaration, or wildcard that defines the content which the particle will match. The occurrence range defines the number of consecutive times the particle will match the input sequence. Particles are grouped together with model-groups (which are in turn contained by their own particles), which allow particles to be matched in “sequence”, or “choice,” or “all” patterns. Together, particles and model groups structure the content model for validating element content, which is eventually validated by element declarations or wildcards. In this way content models of great complexity may be constructed.

In the exemplary embodiments of the present application the technique followed for compilation of ambiguous, but legal content models, is to calculate the occurrence ranges for each of the particles that are specifically prohibited by constructs. The validation code for each particle is then evaluated in a loop conditioned on its effective upper bound. Once the inner loop terminates (either by reaching the effective upper bound, or by reaching an item in the input sequence that does not match the inner particle), the forbidden occurrence ranges are checked, and a range of possible repetitions of the outer particle is calculated. Once the loop on the outer particle terminates, the total range of possible occurrences is checked against the actual bounds of the outer particle. This technique eliminates, completely, the need for a DFA based scheme for evaluating content models, thus rendering a significant gain in complexity, and eliminating code/memory blowup for bounded-range content models.

The formulation of the exemplary embodiments is based on the fact that the Unique-Particle-Attribution constraint prohibits any other forms of ambiguity. For these remaining ambiguities, then, the occurrences of the particle “A” may be efficiently evaluated against the effective upper bounds (e.g., {i*1, j*m}), provided that the individual production sequences are checked against the set of known prohibitions. These functions for prohibited sequences are fixed functions of i, j, l, and m above, which can be calculated at compile time.

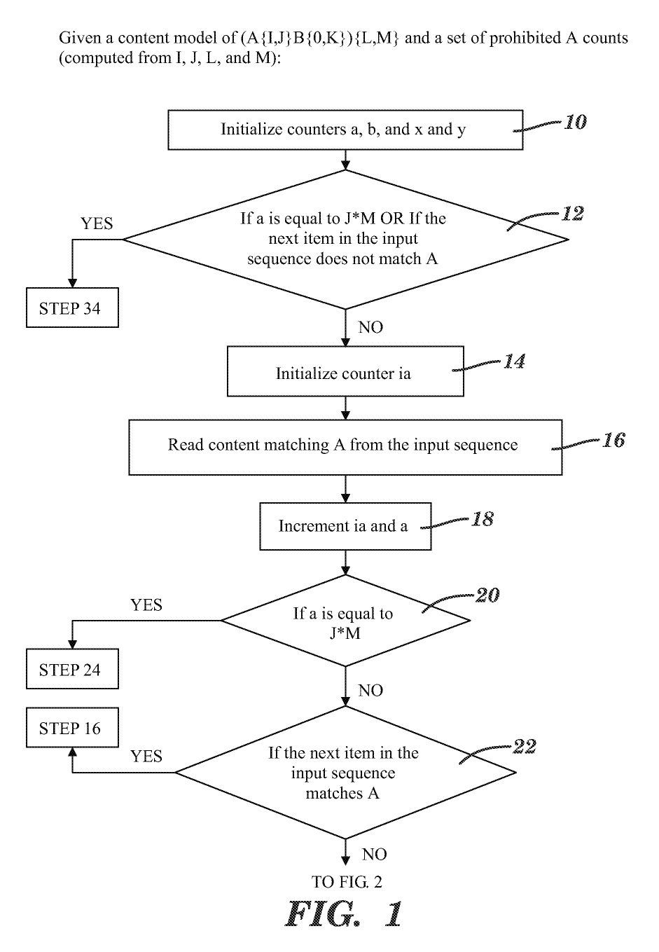

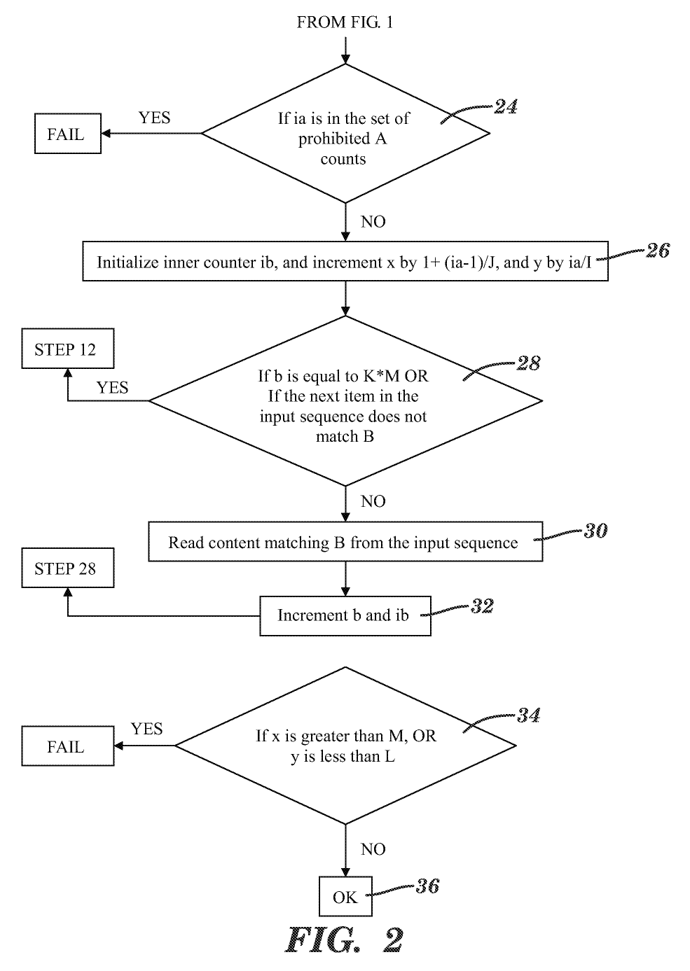

Assuming a computed set of prohibited occurrence counts for the particle “A”, the ambiguous content model (A {I, J} B {0, K}) {L, M} can be validated with the control flow shown in FIGS. 1-2. As FIGS. 1-2 show, the complexity of the control flow for this content model is not dependant on the specific occurrence bounds (I, J, K, L, and M), but rather directly related to the apparent complexity of the content-model expression itself.

Given a content model of (A{I,J}B {0,K}) {L,M} and a set of prohibited A counts (computed from T, J, L, and M) the following steps are performed in FIGS. 1 and 2. In step 10, counters a, b, x, and y are initialized. In step 12, if “a” is equal to J*M or if the next item in the input sequence does not match A, the process flows to step 34 or else the process flows to step 14. In step 14, counter “ia” is initialized. In step 16, content matching A is read from the input sequence. In step 18, “ia” and “a” are incremented. In step 20, if “a” is equal to J*M, the process flows to step 24 or else the process flows to step 22. In step 22, if the next item in the input sequence matches A, the process flows to step 16 or else the process flows to step 24. In step 24, if “ia” is in the set of prohibited A counts the process FAILS or else the process flows to step 26. In step 26, the inner counter “ib” is initialized, and x is incremented by 1+(ia−1)/J, and y by ia/I. In step 28, if “b” is equal to K*M or if the next item in the input sequence does not match B, the process flows to step 12 or else the process flows to step 30. In step 30, content matching B is read from the input sequence. In step 32, “b” and “ib” are incremented and the process flows to step 28. In step 34, if x is greater than M or y is less then L, the process returns “FAIL” or else the process flows to step 36. In step 36, the process flow is completed.

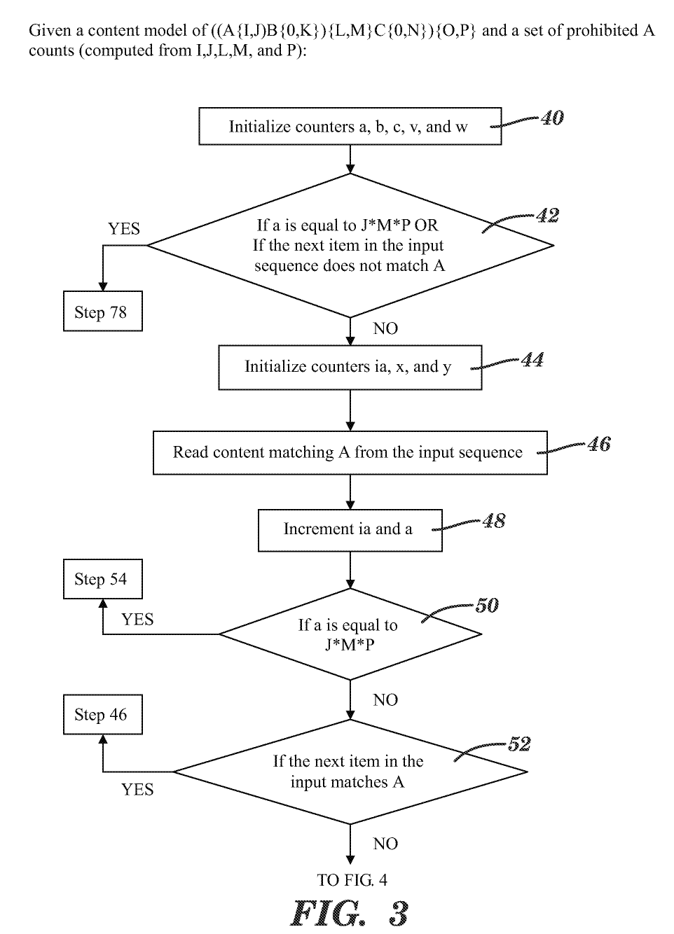

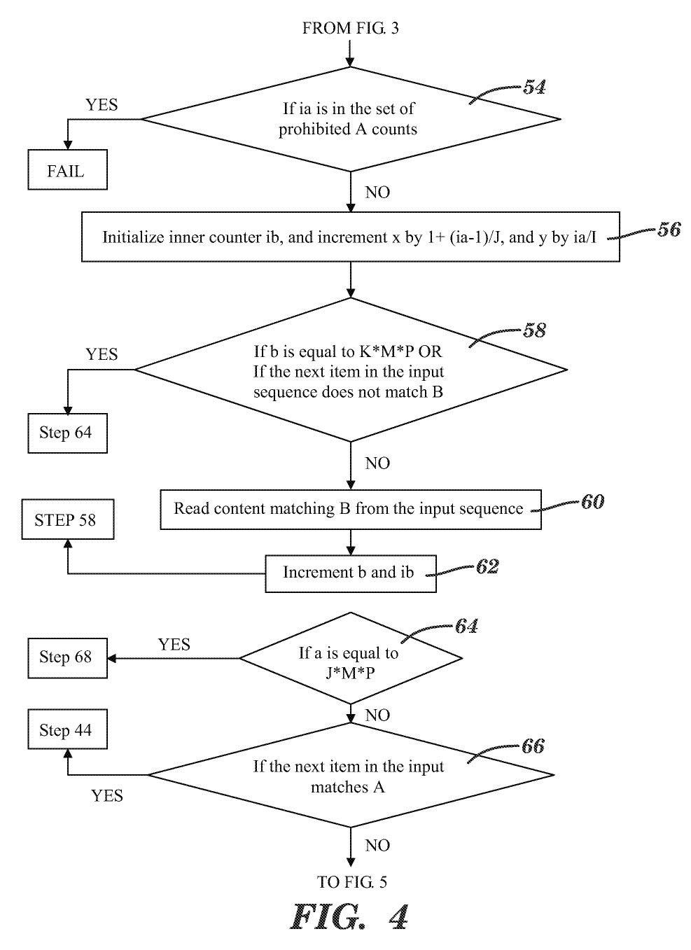

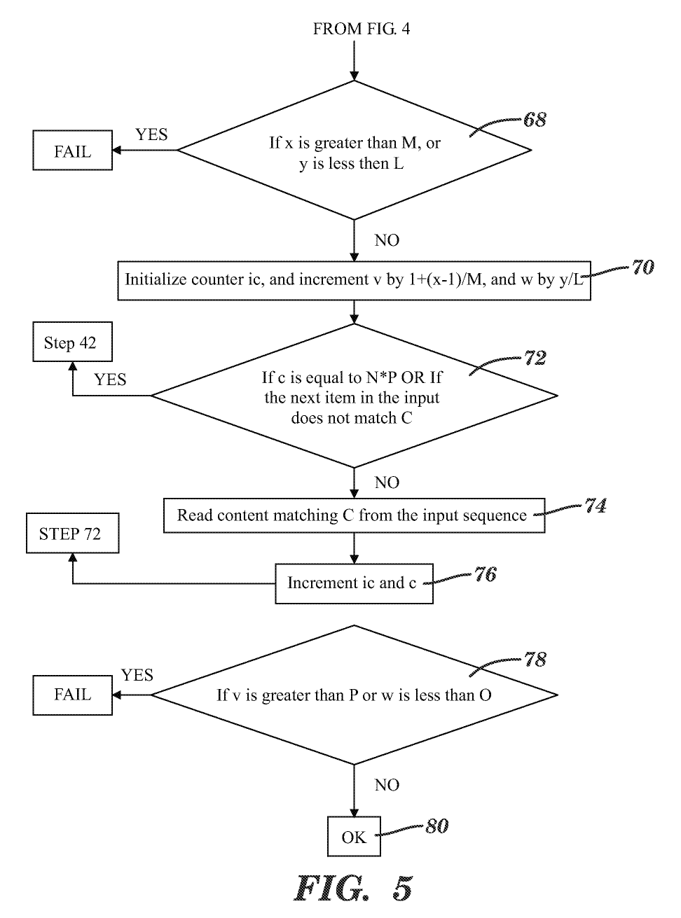

Also, since the nesting loop counts are removed from the formulation, it can be applied at arbitrary levels of nested repetition of the same pattern. For example, for the production ((A {I,J} B {0,K}) {L,M} C {0,N}) {O,P}, and again assuming a computed set of prohibited occurrence counts for “A”, this time a function of (I, J, L, M, O, and P) then the control flow given in FIGS. 3-5 may be utilized. Comparing FIGS. 1 and 2, and FIGS. 3-5, the close relation between the two algorithms demonstrates the simple pattern by which they may be extended to cover further nesting.

Given a content model of ((A{I,J)B{0,K}){L,M}C{0,N}){0,P} and a set of prohibited A counts (computed from I, J, L, M, O, and P) the following steps are performed in FIGS. 3-5. In step 40, counters a, b, c, v, and w are initialized. In step 42, if “a” is equal to J*M*P or if the next item in the input sequence does not match A, the process flows to step 78 or else the process flows to step 44. In step 44, counters ia, x, and y are initialized. In step 46, content matching A is read from the input sequence. In step 48, “ia” and “a” are incremented. In step 50, if “a” is equal to J*M*P the process flows to step 54 where if “ia” is in the set of prohibited A counts, the process returns “FAIL” or else the process flows to step 52. In step 52, if the next item in the input matches A, the process flows to step 46 or else the process flows to step 54. In step 54, if “ia” is in the set of prohibited A counts, the process returns “FAIL” or else the process flows to step 56. In step 56, the inner counter “ib” is initialized, and x is incremented by 1+(ia−1)/J, and y by ia/I. In step 58, if “b” is equal to K*M*P or if the next item in the input sequence does not match B, the process flows to step 64 or else the process flows to step 60. In step 60, content matching B is read from the input sequence. In step 62, “b” and “ib” are incremented and the process flows to step 58.

In step 64, if “a” is equal to J*M*P the process flows to step 68 or else the process flows to step 66. In step 66, if the next item in the input matches A, the process flows to step 44 or else the process flows to step 68. In step 68, if x is greater than M or y is less then L, the process returns “FAIL” or else the process flows to step 70. In step 70, counter “ic” is initialized, and v is incremented by 1+(x−1)/M, and w by y/L. In step 72, if “c” is equal to N*P or if the next item in the input does not match C, the process flows to step 42 or else the process flows to step 74. In step 74, content matching C is read from the input sequence. In step 76, “ic” and “c” are incremented and the process flows to step 72. In step 78, if v is greater than P or w is less than O, the process returns “FAIL” or else the process flows to step 80. In step 80, the process flow is completed.

The influence of the ambiguity extends only through nested productions, which match the canonical example above at each level. Thus, if either of the examples above are contained inside non-problematic content models, the solutions outlined above can be treated as black-box validators for the ambiguous content models, and have no effect on the outer model. Similarly, if the productions for A, B, and C do not match the canonical example, then their content models may be treated as black-box functions, and have no effect on the solutions above.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for generating XML (Extensible Markup Language) parsers through compilation of XML Schema grammars, the method comprising:
parsing an input document with a generated parser, where the generated parser is generated by a three-stage compilation of an XML Schema, where in a first stage the XML Schema is read and modeled in terms of abstract schema components, where in a second stage the XML Schema is augmented with a set of calculated schema components and properties used to drive code generation, and where in a third stage the XML Schema is traversed to generate validation code for each of a collection of elements;
wherein the validation code for ambiguous but legal content models is generated by:
calculating prohibited occurrence ranges for each of the plurality of particles involved;
generating code to:
evaluate each of the plurality of particles in an inner loop conditioned on an effective upper bound;
then, once the inner loop terminates, check forbidden occurrence ranges for an inner particle, and calculate a range of possible repetitions of an outer particle; and
once an outer loop terminates, check a range of total possible repetitions of the outer particle against actual occurrence limits of the outer particle.

2. The method of claim 1, wherein the XML Schema includes either one of: complex types, simple types or a combination of simple types and complex types.

3. The method of claim 1, wherein the XML Schema specifies content models.

4. The method of claim 1, wherein the generated parser is divided into two logical layers, one a scanning layer and the other a validation layer.

5. The method of claim 4, wherein the validation layer is a generated recursive-descent parser that drives a scanner by utilizing compiled, predictive knowledge from the XML Schema.

6. The method of claim 4, wherein the scanning layer includes a set of fixed XML primitives for scanning content at a byte level.
